(19) United States
(12) Patent Application Publication
(10) Pub. No.: US 2014/0263692 A1
(43) Pub. Date: Sep. 18, 2014

(54) Method for Monitoring an Injection Fluid Quantity and Injection System for Injecting an Injection Fluid Quantity

(71) Applicants: Hans-Jörg Wiehoff, Regensburg (DE); Nicolas Nozeran, Tegemheim (DE); Robert Hoffmann, Ruhstorf/Rott (DE)

(72) Inventors: Hans-Jörg Wiehoff, Regensburg (DE); Nicolas Nozeran, Tegemheim (DE); Robert Hoffmann, Ruhstorf/Rott (DE)

(21) Appl. No.: 14/343,907

(22) PCT Filed: Aug. 29, 2012
(86) PCT No.: PCT/EP2012/066785

§ 371 Date: May 30, 2014

(30) Foreign Application Priority Data
Sep. 9, 2011 (DE) 10 2011 082 455.3

(51) Int. Cl. F02M 57/00; F02M 51/06

(52) U.S. Cl. CPC F02M 57/005; F02M 51/0603
USPC 239/1; 239/74

(57) ABSTRACT

A method for monitoring an injection fluid quantity, which is injected through an injection nozzle, includes opening and closing said injection nozzle by a closure element guided in one movement, detecting at least three characteristic points of the movement of the closure element at which the closure element is located at a certain position, and calculating the injection quantity from the at least three detected characteristic points.

### CROSS-REFERENCE TO RELATED APPLICATIONS

This application is a U.S. National Stage Application of International Application No. PCT/EP2012/066785 filed Aug. 29, 2012, which designates the United States of America, and claims priority to DE Application No. 10 2011 082 455.3 filed Sep. 9, 2011, the contents of which are hereby incorporated by reference in their entirety.

### TECHNICAL FIELD

The invention relates to a method for monitoring an injection quantity of a fluid and to an injection system for injecting an injection quantity of a fluid.

### BACKGROUND

Injection systems serve generally for the injection of a predefined injection quantity of a fluid. In automotive engineering, such systems are used for example for the injection of fuel into an internal combustion engine, for example into a diesel engine or into an Otto-cycle engine, of a vehicle. In the case of modern diesel engines, for this purpose, use is made in particular of a common rail injection system. Such injection systems generally have at least one, but preferably multiple, injection nozzle(s) or injection valve(s), which are also referred to as injectors. For improved legibility, the expression “injection nozzle” should hereinafter be understood as also representing injection valves. For the injection of the fuel, a closure element of the injection nozzle is opened, said closure element being closed again after a certain period of time and after a certain quantity of fuel, the injection quantity, has been injected.

Since the engines that are supplied with fuel by means of such systems must not exceed certain exhaust-gas emissions over the entire usage duration thereof, the most accurate possible monitoring of the injected fuel quantity is necessary. Unnecessary exhaust-gas emissions often result from an incorrect injected quantity of fuel, which leads to an undesired air-fuel mixture formation, in the case of which the combustion in a cylinder of the engine cannot take place in optimum fashion. To prevent such an undesired mixture formation, the injection must take place at the correct moment, in the correct form and in the correct volume. This should in particular take place correctly over relatively long periods of time, because injection nozzles can for example become coked over the course of time, with the result that the injection is not performed as desired.

To set the correct volume, it is necessary in particular for an opening and a closing of the injection nozzle to take place at clearly definable points in time. Methods and injection systems for controlling the injection nozzle are already known from the prior art. For example, document DE 103 45 226 A1 discloses a system of said type in which a first point in time, at which the injection nozzle is opened, and a second point in time, at which the injection nozzle is closed, are determined, and an actuation of the injection nozzle takes place as a function of the determined values.

The systems known from the prior art thus make it possible to detect qualitative errors during the opening and closing of the injection nozzle. It is however possible only with difficulty to infer the injection quantity from this.

### SUMMARY

One embodiment provides a method for monitoring an injection quantity of a fluid which is injected through an injection nozzle, wherein the injection nozzle is opened and closed by means of a closing element which is guided in a movement, wherein at least three characteristic points of the movement are detected, at which the closure element is situated in each case at a certain position of the movement, and from which a calculation of the injection quantity is performed.

In a further embodiment, four characteristic points of the movement are detected.

In a further embodiment, the closure element is guided in a lifting movement between a closed position and a lifted position, wherein at least one of the characteristic points comprises a starting point of an opening movement, at which the closure element departs from the closed position for the purpose of opening the injection nozzle; an end point of the opening movement, at which the closure element reaches the lifted position; a starting point of the closing movement, at which the closure element departs from the lifted position for the purpose of closing; or an end point of a closing movement, at which the closure element reaches the closed position for the purpose of closing the injection nozzle.

In a further embodiment, for the calculation of the injection quantity, in a characteristic map of an injection rate, an area enclosed between an axis of the characteristic map and a curve is determined, wherein coordinates of the curve in the characteristic map are defined by the characteristic points and by the injection rates corresponding to the respective characteristic points.

In a further embodiment, the closure element is guided in the movement by means of a drive device, wherein a signal of the drive device is used for the determination of the characteristic points.

In a further embodiment, the signal comprises a capacitance, a voltage, a change in capacitance or a change in voltage of the drive device.

In a further embodiment, the control device actuates the closure element such that at least one of the characteristic points coincides with a predefined target value.

Another embodiment provides an injection system for the injection of an injection quantity of a fluid, comprising a control device and at least one injection nozzle, wherein the injection nozzle has a closure element for closing and opening the injection nozzle, a drive device for guiding the closure element in a movement, and a sensor for detecting positions of the closure element, wherein the sensor is configured to detect at least three characteristic points of the movement at which the closure element is situated in each case at a certain position of the movement, and the injection system comprises a processing unit which is configured to calculate the injection quantity from the characteristic points.

In a further embodiment, the sensor is designed to detect four characteristic points of the movement, wherein it is preferable for the closure element to be guided between a closed position and a lifted position in a lifting movement, and the sensor is configured such that at least one of the characteristic points comprises a starting point of an opening movement, at which the closure element departs from the closed position for the purpose of opening the injection nozzle; an end point of the opening movement, at which the closure element reaches the lifted position; a starting point of the closing movement, at which the closure element departs from the lifted position for the purpose of closing; or an end point of a closing movement, at which the closure element reaches the closed position for the purpose of closing the injection nozzle.

In a further embodiment, the processing unit is configured to calculate the injection quantity from an area enclosed, in a characteristic map of an injection rate, between an axis and a curve, wherein coordinates of the curve in the characteristic map are defined by the characteristic points and by injection rates corresponding to the respective characteristic points.

In a further embodiment, the sensor is configured to detect at least one of the characteristic points on the basis of a signal of the drive device and to transmit said signal to the control device.

In a further embodiment, the signal comprises a capacitance, a voltage, a change in capacitance or a change in voltage.

In a further embodiment, the processing unit is configured to transmit a control signal to the control unit as a function of one of the detected points so that said control unit actuates the closure element such that, during a further run-through of the movement, the detected point coincides with a predefined characteristic point.

In a further embodiment, the drive device has a piezo actuator.

In a further embodiment, the closure element has a nozzle needle.

### BRIEF DESCRIPTION OF THE DRAWINGS

Example embodiments of the invention are explained in more detail below with reference to the drawings, in which:

FIG. 1 is a schematic illustration of an injection system of the proposed type,

FIG. 2 shows profiles with respect to time of a lifting movement of a closure element of the injection nozzle shown in FIG. 1, and

FIG. 3 shows multiple profiles with respect to time of signals of the injection system.

### DETAILED DESCRIPTION

Some embodiments provide a method which overcomes the stated disadvantages, that is to say with which determination and monitoring of an injection quantity of an injection nozzle are also possible quantitatively. Furthermore, it is sought to propose an injection system which permits a quantitative determination of the injection quantity.

For example, some embodiments provide a method for monitoring an injection quantity of a fluid which is injected through an injection nozzle, wherein the injection nozzle is opened and closed by means of a closing element which is guided in a movement, thus provides that at least three characteristic points of the movement are detected. At said points, the closure element is situated in each case at a certain position of the movement, such that a calculation of the injection quantity is performed from the stated points.

Such embodiments are thus based on the realization that the movement of the closure element can be determined with high accuracy and few approximations if certain characteristic points are known. In this way, a calculation of the injection quantity of the fluid can be performed with little measurement and processing outlay. The points taken into consideration for this purpose should be characteristic of the movement of the closure element, such that multiple movements of said type can be distinguished from one another by comparison of the characteristic points, without knowledge of the complete movement being required for this purpose. The expression “characteristic points” is intended here to encompass both points in time and also points in space. The expression “position” is intended to denote any measurement variable that can serve as a measure for the definition of the movement.

To achieve greater accuracy of the method, it may be provided that four characteristic points of the movement are detected. Thus, the injection quantity can be calculated with greater accuracy because there is no need for an approximation for a rising and/or falling flank, it rather being possible for said flanks to be represented by measured points.

The movement itself may be periodic, i.e. with advancing time duration, always the same movement of the closure element is performed repeatedly. This permits a continuous injection, and permanent monitoring, of the injection quantity. The fluid used for the injection is preferably a fuel for an internal combustion engine, for example diesel fuel for a diesel engine or gasoline for an Otto-cycle engine.

The closure element may, for injection, be guided in a lifting movement between a closed position and a lifted position. In the closed position, the closure element completely closes the injection nozzle, such that the fluid cannot emerge from the injection nozzle. Here, the expression “lifted position” is intended to encompass all positions that do not correspond to the closed position. Said expression is thus intended to encompass both a maximum lifted position, in which the closure element is moved as far as a stop of the injection nozzle or a definable maximum point, and a maximum quantity of the fluid is injected, and an only partial opening of the injection nozzle by means of a minimal movement of the closure element. The expression “lifting movement” is intended to encompass not only a raising of the closure element but likewise a lowering of said closure element.

It is preferable for at least one of the characteristic points to comprise a starting point of an opening movement, at which the closure element departs from the closed position for the purpose of opening the injection nozzle; an end point of the opening movement, at which the closure element reaches the lifted position; a starting point of the closing movement, at which the closure element departs from the lifted position for the purpose of closing; or an end point of a closing movement, at which the closure element reaches the closed position for the purpose of closing the injection nozzle. By means of the stated points in time, those positions of the closure element that define the movement of the closure element are linked with a certain time, such that an injection quantity can be calculated. A lifting cycle or injection cycle, that is to say a run-through of the stated four points, is thus divided into an opening flank, a maximum flank and a closing flank. The opening flank is defined by the starting point of the opening movement and by the end point of the opening movement. The closing flank is defined by the starting point of the closing movement and the end point of the closing movement. The maximum flank is that region of the lifting cycle which is situated between the opening flank and the closing flank.

For the calculation of the injection quantity, it may be provided that in a characteristic map of an injection rate, an area enclosed between an axis of the characteristic map and a curve is determined.

The coordinates of the curve in the characteristic map are defined by the characteristic points and by the injection rates corresponding to the respective characteristic points. Here, the expression “injection rate” is intended to describe the injection quantity per unit of time. Said injection rate may be defined from the positions of the closure element, which predefine a present throughflow of the fluid to be injected and thus a present injection quantity, and from the points in time. In particular, for the calculation, the injection rate may be plotted on an ordinate of the characteristic map, whereas the time is plotted on an abscissa. The area enclosed by the curve produced by the characteristic points thus constitutes a measure for the injection quantity. The area may be calculated by adding up area parts bounded by the curve or by integration of the curve.

The closure element may be guided in the movement by means of a drive device, wherein a signal of the drive device is used for the determination of the characteristic points. In this way, additional measurement systems and/or additional method steps are omitted because the drive device that is required in any case for the movement of the closure element can also be used for the determination of the characteristic points. The signal of the drive device may preferably comprise a capacitance, a voltage, a change in capacitance or a change in voltage of the drive device.

Furthermore, a control device may actuate the closure element such that at least one of the characteristic points coincides with a predefined target value that corresponds to said one of the characteristic points. The control device is thus provided for regulating the injection quantity by adapting the movement of the closure element. Here, the predefined target values may be predefined positions of the closure element or else predefined points in time at which the closure element is intended to be situated at certain positions. The target values corresponding to the characteristic points may for example be defined by means of a predefined time interval, wherein a start of said interval is defined by one of the detected characteristic points and the target value forms the end of the interval.

An injection system for the injection of an injection quantity of a fluid comprises a control device and at least one injection nozzle. The injection nozzle has a closure element for closing and opening the injection nozzle, a drive device for guiding the closure element in a movement, and a sensor for detecting positions of the closure element. The sensor is configured to detect at least three characteristic points of the movement at which the closure element is situated in each case at a certain point of the movement. Furthermore, the injection system comprises a processing unit which is configured to calculate the injection quantity, for example of the injection cycle, from the characteristic points. The stated components of the injection system thus permit both the movement of the closure element and also the reliable detection of the respective positions and the resulting injection quantity.

The sensor may furthermore be configured to detect four characteristic points of the movement, in order to reproduce the movement with the greatest possible accuracy without driving up processing outlay to too great an extent. The closure element may be guided between a closed position and a lifted position in a lifting movement which is preferably periodic. The sensor may be configured such that at least one of the characteristic points comprises a starting point of an opening movement, at which the closure element departs from the closed position for the purpose of opening the injection nozzle; an end point of the opening movement, at which the closure element reaches the lifted position; a starting point of the closing movement, at which the closure element departs from the lifted position for the purpose of closing; or an end point of a closing movement, at which the closure element reaches the closed position for the purpose of closing the injection nozzle.

In one embodiment, the processing unit may be configured to calculate the injection quantity from an area enclosed, in a characteristic map of an injection rate, between an axis and a curve. Here, coordinates of the curve in the characteristic map are defined by the characteristic points and by injection rates corresponding to the respective characteristic points. In particular, for the calculation, the injection rate may be plotted on an ordinate, that is to say a vertical axis of the characteristic map, of the characteristic map, whereas the time is plotted on an abscissa, that is to say a horizontal axis. The processing unit can calculate the area, and thus also calculate the injection quantity, by adding up individual area parts or by integration of the curve.

It may be provided that the sensor is configured to detect at least one of the characteristic points on the basis of a signal of the drive device and to transmit said signal to the control device. For this purpose, the sensor is preferably mounted directly in the drive device. In this way, further measurement devices are omitted, because a signal provided directly by the drive device is used as a measure for the presence of characteristic points. The signal may preferably comprise a capacitance, a voltage, a change in capacitance or a change in voltage.

The processing unit may be configured to transmit a control signal to the control device as a function of one of the detected points so that said control device actuates the closure element such that, during a further run-through of the movement, the characteristic point coincides with a predefined characteristic point. In this way, regulation of the movement of the closure element and thus regulation of the injection quantity is performed, which regulation goes beyond mere monitoring of the injection quantity. The predefined characteristic point serves in this case as a target value, with actuation to said target value being performed with the greatest possible accuracy during the further lifting cycle.

The drive device may advantageously have a piezo actuator such as is used in modern injection systems. In the case of the piezo actuator, it is furthermore possible for the capacitance, the voltage or changes in said variables to be determined in a very simple manner. Alternatively, instead of the piezo actuator, the drive device may also comprise a magnet coil.

Furthermore, the closure element may have a nozzle needle. The nozzle needle is a conventional component for the opening and closing of injection nozzles and, for this purpose, is seated on a nozzle needle seat when in the closed position, said nozzle needle seat hereby being completely closed. The movement of the nozzle needle is also referred to as needle lift, wherein furthermore, needle lift sensors exist which are used for the detection of positions of the nozzle needle and which may also be a constituent part of the sensor of the injection system.

The method and the injection system are preferably used in an internal combustion engine. An internal combustion engine of said type may for example comprise a diesel engine, preferably a common-rail diesel engine.

The injection system is preferably configured to carry out the described method.

FIG. 1 illustrates, in a block diagram and in a schematic view, an injection system 1 for the injection of an injection quantity of a fluid. The injection system 1 comprises a control device 2 and an injection nozzle 3 and a processing unit 4. The injection nozzle 3 comprises a closure element 7, in the illustrated exemplary embodiment a nozzle needle, which lies in a nozzle needle seat, and said injection nozzle also comprises a drive device 5 and a sensor 6. The drive device 5 is a piezo actuator which, by the application of a voltage, changes a shape of a piezo crystal contained therein and thus raises or lowers the closure element 7, that is to say guides the closure element 7 in a lifting movement. The closure element 7 is for this purpose rigidly connected to the drive device 5 and is pushed downward from a surrounding wall 10 of the injection nozzle 3 by means of a spring 9, such that in the rest state, that is to say when the drive device 5 is not actuated, the closure element 7 closes the injection nozzle 3, more precisely the holes 11 of the injection nozzle 3. Instead of the piezo actuator, the drive device 5 may also comprise a magnet coil.

The sensor 6 is a capacitance sensor which has two parallel plates mounted on opposite sides of the closure element 7. If the closure element 7 is moved by the drive device 5, the capacitance measured by the sensor 6 changes. Here, the sensor 6 is mounted directly on the drive device 5, or may also be a part of the drive device 5. Instead of a capacitance sensor, it is also possible for a sensor for measuring a voltage of the piezo actuator to be provided. The voltage can be easily determined as a signal of the piezo actuator, wherein, with knowledge of a charge of the piezo actuator, for example with knowledge regarding an applied current, the capacitance can also additionally be determined. The sensor 6 may however also be configured to qualitatively and quantitatively detect changes in the stated measurement variables.

By means of a method explained in more detail in conjunction with FIGS. 2 and 3, the sensor 6 detects characteristic points of the lifting movement of the closure element 7 from the profile with respect to time of the capacitance. The capacitance measured by the sensor 6 and the characteristic points are transmitted via a line 8, which may comprise an electrical cable line or a wireless radio connection, to the processing unit 4 which calculates the injection quantity from said data. The method used by the processing unit 4 for the calculation of the injection quantity will be explained in more detail on the basis of FIG. 3. In the present exemplary embodiment, the four characteristic points comprise a starting point of an opening movement, at which the closure element 7 departs from the closed position for the purpose of opening the injection nozzle 3; an end point of the opening movement, at which the closure element 7 reaches the maximum lifted position; a starting point of the closing movement, at which the closure element 7 departs from the maximum lifted position for the purpose of closing; and an end point of a closing movement, at which the closure element 7 reaches the closed position again for the purpose of closing the injection nozzle 3. The lifted position used here is the maximum lifted position, that is to say the position in which the spring 9 is compressed to a maximum extent and the closure element 7 thus abuts against an upper end of the surrounding wall 10.

The closure element 7 is thus guided constantly upwards and downwards in the periodic lifting movement, whereby a fuel, in the illustrated exemplary embodiment diesel fuel, from the injection system 1 is injected through a feed line (not illustrated in FIG. 1) into a cylinder (likewise not illustrated, for reasons of clarity) of a diesel engine.

The processing unit 4 is a constituent part of an on-board computer of a vehicle in which the injection system 1 is installed. The processing unit 4 is connected to the control device 2 via a further line 8′ which, like the line 8, may be realized without cables or by means of cables. The processing unit 4 compares the determined injection quantity with a predefined value of the injection quantity or individual or all of the characteristic points with predefined target values of the characteristic points, and if the determined values deviate from the target values, transmits a control signal to the control device 2 via the line 8′. The control device 2 controls the drive device 5, and thus the movement of the closure element 7, via a line 8″ which may likewise be realized without cables or by means of cables. To reduce deviations, the control device 2 now actuates the drive device 5 such that, during a new run-through of a lifting cycle, at least one or all of the characteristic points coincide(s) with the target values as predefined characteristic points. This regulation may comprise an earlier or later opening or closing of the closure element 7 in relation to a preceding lifting cycle. Here, the target values are defined by means of a time interval with respect to a certain event, in the illustrated exemplary embodiment the starting time of the opening movement. The control device 2 is likewise part of the on-board computer. The entire injection system 1 is in the present case incorporated into an on-board diagnosis (OBD) system.

FIG. 2 illustrates two variants of profiles with respect to time of the lifting movement of the closure element 7. Here, FIGS. 2a) and 2b) illustrate examples of a profile of said type which differ in terms of their form. In this figure, and also in the following figure, repeated features are denoted by identical reference signs. In FIG. 2a) and also in FIG. 2b), the time is plotted on an abscissa 12, whereas a needle lift, that is to say a height of the nozzle needle as closure element 7 above the closing position, is plotted on an ordinate 13. The movement of the closure element 7 can be characterized by the four characteristic points 14, 15, 16 and 17, specifically the starting point of the opening movement 14, the end point of the opening movement 15, the starting point of the closing movement 16, and the end point of the closing movement 17. At the starting point of the opening movement 14, the closure element 7 is moved away from the closed position and raised as far as the end point of the opening movement 15. In the exemplary embodiment illustrated, a maximum needle lift 18 is 100 μm. In the exemplary embodiment illustrated in FIG. 2a), said opening movement, which is also referred to as the opening flank of the movement of the closure element 7, takes place linearly. The maximum needle lift 18, at which the closure element 7 is situated at the end of the opening movement, denotes the upper stop point. The closure element 7 remains in said position for a period of time between the end point of the opening movement 15 and the starting point of the closing movement 16, said time period also being referred to as maximum flank. A maximum possible quantity of the fuel can be generated during said time period. Proceeding from the starting point of the closing movement 16, the closure element 7 moves in the direction of the closed position again, which it finally reaches at the end point of the closing movement 17. In the exemplary embodiment shown, said movement, also referred to as the closing flank of the movement of the closure element 7, is considerably shorter than the opening flank, but likewise linear.

In the exemplary embodiment shown in FIG. 2b), four characteristic points 14, 15, 16, 17 are shown which are identical in terms of their coordinates, defined by a point in time and a lifted position, to the characteristic points 14, 15, 16, 17 of FIG. 2a). By contrast to FIG. 2a), however, the opening flank between the starting point of the opening movement 14 and the end point of the opening movement 15 and the closing flank between the starting point of the closing movement 16 and the end point of the closing movement 17 do not run linearly, and instead run in an exponentially rising fashion in the opening flank and in a likewise non-linearly falling fashion in the closing flank. In the exemplary embodiment illustrated, the form of the opening flank and of the closing flank is dependent on the fuel which is used and is correspondingly predefined for the processing unit 4 before a calculation of the injection quantity. That is to say, based on the four characteristic points 14, 15, 16, 17, the processing unit 4 connects said points to one another by means of predefined mathematical functions.

In an exemplary embodiment which is not illustrated here, it is also possible for only three of the characteristic points 14, 15, 16, 17 to be determined by means of the sensor 6. The missing point for the complete description of the lift profile shown in FIGS. 2a) and 2b) is in this case determined by means of two adjacent points and the predefined mathematical functions, for example by means of two intersecting lines of best fit. In a special case, it may in particular be that the end point of the opening movement 15 and the starting point of the closing movement 16 coincide, that is to say the maximum flank is defined only by said point.

FIG. 3 illustrates multiple signal profiles of the closure element 7. In each of FIGS. 3a) to 3d), the time is plotted on the abscissa 12; a current applied to the drive device 5 is plotted on an ordinate 18 in FIG. 3a), a voltage applied to the drive device 5 is plotted on an ordinate 19 in FIG. 3b), the capacitance 15 of the drive device 5 as measured by the sensor 6 is plotted on an ordinate 20 in FIG. 3c), and the injection rate is plotted on an ordinate 21 in FIG. 3d).

The profile with respect to time, illustrated in FIG. 3a), of the current used for the actuation of the drive device 5 initially rises proceeding from a zero line in order to bring about a change in the voltage of the piezo actuator as drive device 5 for the closure element 7. A resulting increase of the voltage is illustrated in FIG. 3b). As a result of the change in the current, that is to say the number of charge carriers, and the change in voltage, a change in capacitance of the piezo actuator occurs, as illustrated in FIG. 3c). Said change in capacitance likewise takes place up to a certain maximum value beyond which the voltage and consequently also the capacitance increase no further. In the exemplary embodiment illustrated in FIG. 3, the sensor 6 determines the four characteristic points 14, 15, 16, 17 from the capacitance profile shown in FIG. 3c), and the injection rate is determined from said points by the processing unit 4.

The starting time of the opening movement 14 is determined by an attainment of a first local maximum 22 of the capacitance, which can also be determined by a zero point of a profile of a change in capacitance, that is to say of a derivative of the capacitance profile. The end point in time of the opening movement 15 is determined by an attainment of a second local maximum 23 of the capacitance. The starting point of the closing movement 16 is determined by an initial exceedance of a capacitance threshold value and/or an initial exceedance of a voltage threshold value 24. The oscillations of the capacitance that are visible in FIG. 3c) originate from a post-pulse oscillation of the drive device 5 after the current direction has reversed. Said post-pulse oscillation causes oscillations in the capacitance, wherein the end of the closing movement 17 is reached when a first local minimum 25 of said oscillations is attained. As an alternative to the described method, it is also possible in a further embodiment for an overshooting or undershooting of changes in capacitance to be used for the determination of the characteristic points 14, 15, 16, 17. It is however also possible to resort to a direct signal of the drive device 5, such as the voltage illustrated in FIG. 3b) or a change in the voltage.

The injection quantity is calculated by the processing unit 4 by integration of an area 26 situated beneath the curve in FIG. 3d). Aside from integration, the area 26 situated beneath the curve may also be performed by adding up areas of three area parts, specifically the area part situated beneath the start flank, the area part situated beneath the maximum flank, and the area part situated beneath the end flank. The formulae for the calculation of the area under the respective flanks may be predefined for this purpose, and in the simplest case are linear. The lower boundary of said area is in this case defined by the plotted zero line which, for improved clarity, has been illustrated raised from the abscissa 12. If the determined injection quantity deviates from its target value, for example because an end point in time of the opening movement 15′ is reached too early and thus the injection quantity is too large, the drive device 5 is actuated by the control device 2 such that the closure element 7 is opened more slowly during the next lifting cycle, and thus the end point in time of the opening movement 15 coincides again with its target value.

Features of the various embodiments disclosed only in the exemplary embodiments may be combined with one another and claimed individually.

What is claimed is:

1. A method for monitoring an injection quantity of a fluid which is injected through an injection nozzle, comprising:
opening and closing the injection nozzle using a closing element which is guided in a movement,
detecting at least three characteristic points of the movement at which the closure element is situated at a certain position of the movement, and
calculating the injection quantity based on the at least three detected characteristic points.

2. The method of claim 1, comprising detecting four characteristic points of the movement.

3. The method of claim 1, wherein:
the closure element is guided in a lifting movement between a closed position and a lifted position, and
at least one of the characteristic points comprises at least one of:
a starting point of an opening movement at which the closure element departs from the closed position for the purpose of opening the injection nozzle;
an end point of the opening movement at which the closure element reaches the lifted position;
a starting point of the closing movement at which the closure element departs from the lifted position for the purpose of closing; and
an end point of a closing movement at which the closure element reaches the closed position for the purpose of closing the injection nozzle.

4. The method of claim 1, wherein:
calculating the injection quantity comprises determining, in a characteristic map of an injection rate, an area enclosed between an axis of the characteristic map and a curve, and
coordinates of the curve in the characteristic map are defined by the characteristic points and by the injection rates corresponding to the respective characteristic points.

5. The method of claim 1, wherein the closure element is guided in the movement by means of a drive device, and wherein a signal of the drive device is used for the determination of the characteristic points.

6. The method of claim 5, wherein the signal comprises at least one of a capacitance, a voltage, a change in capacitance, and a change in voltage of the drive device.

7. The method of claim 1, wherein the control device actuates the closure element such that at least one of the characteristic points coincides with a predefined target value.

8. An injection system for the injection of an injection quantity of a fluid, comprising:
a control device, and
at least one injection nozzle, each injection nozzle has comprising:
a closure element for closing and opening the injection nozzle,
a drive device for guiding the closure element in a movement, and
a sensor for detecting positions of the closure element,
wherein the sensor is configured to detect at least three characteristic points of the movement at which the closure element is situated at a certain position of the movement, and
a processing unit configured to calculate the injection quantity from the at least three detected characteristic points.

9. The injection system of claim 8, wherein:
the sensor is configured to detect four characteristic points of the movement,
the closure element is guided between a closed position and a lifted position in a lifting movement, and
the sensor is configured such that at least one of the characteristic points comprises at least one of:
a starting point of an opening movement at which the closure element departs from the closed position for the purpose of opening the injection nozzle;
an end point of the opening movement at which the closure element reaches the lifted position;
a starting point of the closing movement at which the closure element departs from the lifted position for the purpose of closing; and
an end point of a closing movement at which the closure element reaches the closed position for the purpose of closing the injection nozzle.

10. The injection system of claim 8, wherein the processing unit is configured to calculate the injection quantity from an area enclosed, in a characteristic map of an injection rate, between an axis and a curve, wherein coordinates of the curve in the characteristic map are defined by the characteristic points and by injection rates corresponding to the respective characteristic points.

11. The injection system of claim 8, wherein the sensor is configured to detect at least one of the characteristic points on the basis of a signal of the drive device and to transmit said signal to the control device.

12. The injection system as of claim 11, wherein the signal comprises a capacitance, a voltage, a change in capacitance or a change in voltage.

13. The injection system of claim 8, wherein the processing unit is configured to transmit a control signal to the control unit as a function of one of the detected points such that said control unit actuates the closure element such that, during a further run-through of the movement, the detected point coincides with a predefined characteristic point.

14. The injection system of claim 8, wherein the drive device has a piezo actuator.

15. The injection system of claim 8, wherein the closure element has a nozzle needle.
